(19) United States
(12) Patent Application Publication
(10) Pub. No.: US 2013/0216692 A1
(43) Pub. Date: Aug. 22, 2013

(54) SUBSTANCE MIXTURES

(71) Applicant: Symrise AG, (US)

(72) Inventors: Christopher Sabater, Holzminden (DE); Thomas Riess, Holzminden (DE); Dirk Schrader, Holzminden (DE); Christina Sleet, Buckinghamshire (GB)

(73) Assignee: Symrise AG, Holzminden (DE)

(21) Appl. No.: 13/766,050

(22) Filed: Feb. 13, 2013

(30) Foreign Application Priority Data
Feb. 19, 2012 (EP) 12156104.7

(51) Int. Cl. A23L 1/22

(52) U.S. Cl. CPC A23L 1/22091
USPC 426/650; 426/471

(57) ABSTRACT

Substance mixtures are proposed, comprising
(a) polyphenols, flavonoids and/or diterpene glucosides,
(b) polysaccharides and optionally
(c) saponins
   with the proviso that the content of arabinogalactan proteins in component (b) is at least 11% by weight.

### AREA OF THE INVENTION

The invention relates to the field of aroma substances and further relates to new substance mixtures with improved solubility properties and improved flavour properties, a process for their preparation, and their use in food products.

### STATE OF THE ART

Polyphenols and diterpene glucosides in general and flavonoids in particular are secondary plant substances, including, for example, a large part of dyes obtained from flower petals. Plants containing a high content of polyphenol are, for example, chokeberries, the leaves and grapes of wine, the pulp of mangosteen (Garcinia mangostana), the juice of the pomegranate (Punica granatum), and the leaves of red clover, ginkgo and green tea, just to mention a few. In addition, flavonoids are mostly extracted from pine bark and larch wood. These substances have been used in natural medicine for a long time. They have been known for their anti-allergic, anto-phlogistic, anti-microbial, anti-oxidant, anti-proliferative and anti-carcinogene effects. In the field of the food production industry, polyphenols are particularly used as additives for beverages such as, for example, lemonades or iced teas; besides their valuable health-promoting properties they feature a sweet taste or a taste that is capable of masking bitterness.

A considerable disadvantage, however, is that said active agents are soluble in water only in very small quantities; once incorporated into the final formulations they rather tend to fall out over time, which does not have a truly negative effect on the quality of the product. From the consumer's point of view, this is clearly undesired for aesthetic reasons and thus negatively influences his or her purchasing decision.

However, a number of solutions for the problem described above is known from the state of the art.

For example, WO 2007 122251 A1 (Symrise) describes a synergistic mixture, wherein glycosyl flavanones are mixed with maltodextrines and gum arabic to enhance stability. Subsequently, the mixtures are subjected to spray drying.

International patent application WO 2007 107596 A1 (Symrise) discloses the use of 4-hydroxydihydrochalcones and the salts thereof to intensify the sweet taste of substances intended for consumption. Example 3 describes the spray-drying of a mixture of phloretin, maltodextrin and conventional gum arabic.

International patent application WO 2011 089247 A1 (Symrise) describes liquid solubilising agents for polyphenols, comprising at least one polymer emulsifier, saponins and aliphatic alcohols or polyols.

However, the solutions suggested in the state of the art are not completely satisfactory. For example, the spray-dried solubilising agents are insufficient with regard to their taste, while the liquid solubilising agents are attractive as regards taste; however, these can incorporate only a comparably small quantity of active agents, as their storage stability is limited. In addition, the solutions mentioned are use-oriented, as no stable solution was obtainable for dry mixtures.

Consequently, the object of the present invention was to provide substance mixtures on the basis of polyphenols, flavonoids or diterpene glucosides, which show an increased contents in those active agents in comparison with the state of the art and which are clearly soluble in food products, particularly, in beverages. At the same time, the substance mixtures should provide an improved mouth feel and a fuller taste, specifically, an improvement in the fruit profile when used in said food products and, particularly, in beverages, which are often based on dry concentrates such as, for example, iced tea.

### DESCRIPTION OF THE INVENTION

The subject matter of the invention are substance mixtures, comprising

(a) polyphenols, flavonoids and/or diterpene glucosides,
(b) polysaccharides and, optionally,
(c) saponins
with the proviso that the content of arabinogalactan proteins in component (b) amounts to at least 11% by weight.

Surprisingly it has been found that the use of particular polysaccharides having a high content of arabinogalactan proteins and, preferably, in addition, a low content of ash, allowed the production of dry powders or granulates, which—in comparison to known liquid preparations—are already characterised by their high content of polyphenols, flavonoids, or diterpene glucosides. The substance mixtures which are preferably obtainable by spray drying or freeze drying of corresponding aqueous solutions or dispersions, are clearly soluble and also provide the desired improved flavour properties: the mouth feel is improved, the taste is fuller, fruitiness—particularly in the flavours peach and lemon—is increased, and the bitterness of some flavonoids is masked. This is even more surprising, as not only the water is removed from the mixtures by drying, but also the solvent system is changed by drying.

### Polyphenols, Flavonoids and Diterpene Glucosides

The selection of active agents suitable as component (a) is mostly uncritical and is exclusively directed at their usability in the field of food preparations. This includes that, according to the claims, also polymers can be used which should rather not be used for physiological reasons, for example, quercetin. It is also obvious that the invention allows the loading of the carrier materials with active agents in quantities that are not suitable any more for specific uses. It is pointed out though that this concerns individual cases. The expert to whom the technical teaching is directed, certainly knows how to select the active agents which are physiologically acceptable and to dose them accordingly—either when loading the carriers or when adding the substance mixtures to the food products—such that this does not present any health risk. Therefore, the expert is very well capable of making the right decision with respect to this aspect of the invention without having to carry out a testing programme or having to be inventive.

With respect to component (a), the invention comprises polyphenols, flavonoids and diterpene glucosides, wherein it is obvious that the flavonoids themselves are a subgroup of the polyphenols. In fact, the flavonoids within the meaning of the invention are the preferred active agents; they are derived from the structure of flavan and consist of two aromatic rings, which are connected by a tetrahydropyran ring.

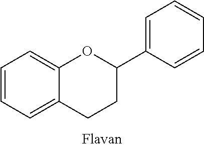 [SMILES: c1ccc(C2CCc3ccccc3O2)cc1]

Consequently, the structure of the flavonoids also consists of two aromatic rings, which are linked by a C3 bridge. Ring A usually shows the substitution pattern of phloroglucin, which refers to ist acetogenin origin. Ring B, which often carries a hydroxyl group at the 4-position (more rarely at the 3′- or 3′- and the 5′-position), and the C3-bridge origin from the shikimic acid pathway. Very often, said bridge is closed to form an O-heterocyclic ring, wherein the subgroup of the chalcones forms an exception. In total, more than 8000 different flavonoids are known and described. Depending on the degree of oxidation of the C3 bridge they are classified into different subgroups. Accordingly, the following flavonoid groups are also preferred components (a) as represented in the following Table 1 (cf. Wikipedia, key word “Flavonoids”).

TABLE 1
Overview of preferred flavonoid classes

| Class | Structure | Examples |
|---|---|---|
| Chalcones | 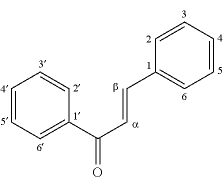 [SMILES: O=C(/C=C/c1ccccc1)c1ccccc1] | Isoliquitigenin, Xanthohumol, Phloretin |
| Flavones | 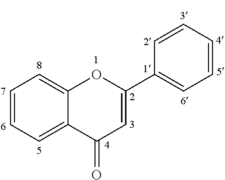 [SMILES: O=c1cc(-c2ccccc2)oc2ccccc12] | Luteolin, Apigenin |
| Flavonols | 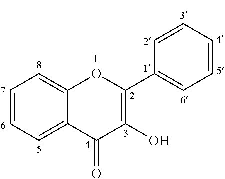 [SMILES: O=c1c(O)c(-c2ccccc2)oc2ccccc12] | Morin, Rutin, Kaempferol, Myricetin, Isorhamnetin, Fisetin |
| Flavanols | 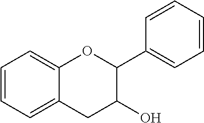 [SMILES: OC1Cc2ccccc2OC1c1ccccc1] | Catechin, Gallocatechin, Epicatechin, Epigallocatechin gallate |
| Flavanones | 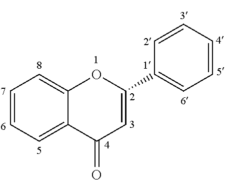 | Hesperetin, Naringenin, Eriodictyol |
| Flavanonols | 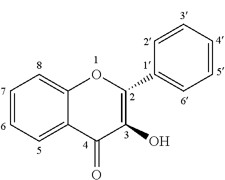 | Taxifolin |
| Isoflavones | 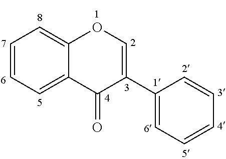 [SMILES: O=c1c(-c2ccccc2)coc2ccccc12] | Genistein, Daidzein, Licoricidin |
| Anthocyanidines (Anthocyanins) | 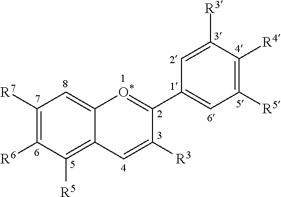 | Cyanidin, Delphinidin, Malvidin, Pelargonidin, Peonidin, Petunidin |
| Aurones | 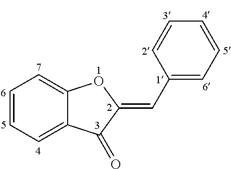 [SMILES: O=C1/C(=C/c2ccccc2)Oc2ccccc21] | Aureusidin |

Particularly advantageous solubility properties and flavour properties are obtained within the meaning of the invention when flavonoids of the dihydrochalkone type or flavanones are used as component (a).

A particularly preferred form of embodiment is the use of two particular flavonoids, which are, namely, phloretin, hesperetin or the mixtures thereof:

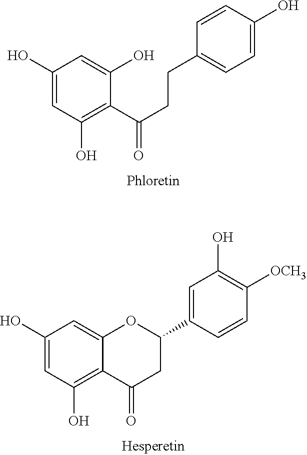 [SMILES: O=C(CCc1ccc(O)cc1)c1c(O)cc(O)cc1O ; COc1ccc([C@@H]2CC(=O)c3c(O)cc(O)cc3O2)cc1O]

### Polysaccharides

Suitable polysaccharides for use as carriers (component b) for the active agents described above are, preferably, condensation products of arabinose, galactose, rhamnose and/or glucoronic acid in general, and gum arabic in particular.

Gum arabic comprises colorless to brown, matte, brittle, odorless pieces having a glossy fracture or powders which dissolve in warm water to give a clear, viscous, tacky, insipid-tasting and weakly acidic liquid. Gum arabic is substantially insoluble in alcohol.

The substance consists mainly of the acidic alkaline earth metal and alkali metal salts of so-called arabic acid (polyarabic acid), which is understood as meaning a branched polysaccharide consisting of L-arabinose, D-galactose, L-rhamnose and D-glucuronic acid in the ratio 3:3:1:1. Conventional gum arabic exhibits a content of arabinogalactan proteins in a range of about 6 to 10% by weight maximum and has proved unsuitable as a carrier material within the meaning of the present invention. According to the invention, only such polysaccharides or gum arabic can be used which contain a minimum of about 11, preferably, from about 12 to about 30, and specifically from about 15 to 20% by weight arabinogalactan proteins. It is, furthermore, advantageous when the ash content—i.e. the content of arabic acid salts—of the carriers is less than about 1% by weight and, preferably, from about 0.2 to about 0.5% by weight, thus being at least 75% lower than in conventional commercial products (about 4% by weight).

### Saponins

Saponins, which may optionally be present as additional carrier materials (optional component c) in the substance mixtures, are glycosides of steroids, steroid alkaloids and triterpenes. The name saponins is derived from their capability to produce stable foams, as soaps do. The saponins found in the horse-chestnut are known, which are used as detergents. Due to the multitude of possible carbohydrate structures and due to the large structural variability of the aglycones, this group of substances shows a correspondingly large variety in structure and thus a large variability in the biologic properties. Within the meaning of the invention, obviously, only such saponins are suitable which do not present any health risk and are approved for food purposes, similarly to the polysaccharides. The expert knows which saponins fulfil this condition; for example, saponins derived from steroid alkaloids are barely suitable for the production of the substance mixtures according to the invention due to their predominantly poisonous character. Conversely, particularly suitable saponins are the ones obtained on the basis of tomatoes, potatoes, soy beans, chestnuts, herbs or tea plants.

In a particularly preferred embodiment of the present invention, saponins are used which comprise quillaic acid as aglycon.

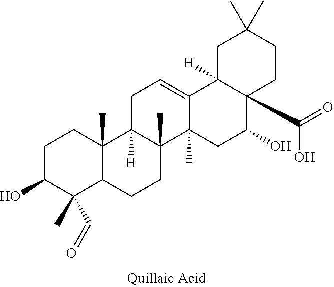

The corresponding saponins are generally obtained from the bark of the so-called “soap bark tree” (Quillaja saponaria), which is native to Chile.

Saponins in general and Quillaja saponins in particular are, preferably, aqueous or alcoholic extracts, which contain, in particular, from about 2 to about 50, more particularly, from about 5 to about 35, and particularly preferably, from about 10 to about 25% by weight triterpene saponins, wherein these indications of quantity relate to the saponin extract. The triterpens are usually linked to glycones in the 3- and 28-position, wherein about 50 different Quillaja saponins are known to this date. The molecular weight of the saponins is, preferably, in the range of from about 1,300 to about 2,600, and particularly preferably, of from about 1,800 to about 2,000 Dalton. Below 500 ppm, the saponins are present as monomers, and above this value they aggregate to form micelles with molecular weights in the range of 100,000 Dalton. With regard to methods of obtaining Quillaja saponins we refer to the publications U.S. Pat. No. 5,057,540 and U.S. Pat. No. 5,817,314.

### Substance Mixtures

The saponins are generally used within the meaning of the invention as co-carrier materials, i.e. their proportion in the carrier is usually below 50% by weight and thus below the amount of polysaccharides used; however, this is not mandatory. The preferred mixing ratio between the two components (b) and (c) amounts from about 20:1 to about 1:2, particularly preferably, from about 12:1 to about 1:1 and, specifically, from about 10:1 to about 2:1, based on the weight.

In contrast to this, the substance mixtures may comprise components (a) and (b+c) in the weight ratio of about 1:99 to about 80:20, preferably, from about 40:60 to about 20:80 and specifically from about 20:80 to about 30:70.

The substance mixtures contain a residue water content of typically less than 5% by weight, preferably, less than 4% by weight. Particularly, the substance mixtures are nearly water-free. In addition, they may comprise triacetin, polyols (for example, propylene glycol or glycerol) and traces of aliphatic alcohols, specifically, ethanol, in subordinated amounts.

### Process of Production

A further subject matter of the invention relates to a process for the production of the substance mixtures, in which
(a) polyphenols, flavonoids and/or diterpene glucosides are dissolved or dispersed in a solvent mixture consisting of triacetin, polyols and alcohols,
(b) the solution or dispersion such obtained is reacted with an aqueous polysaccharide solution with a content of arabinogalactan proteins in gum arabic of at least 11% by weight and, optionally, saponins,
(c) the mixture obtained is dehydrated up to a residual content of a maximum of 5, preferably, of a maximum of 4, and most preferably, below 2% by weight water and, optionally,
(d) the dried product is ground or granulated to a powder.

The solvents or dispersants for the active agents according to the invention are composed of
water,
triacetin,
polyols (for example, ethylene glycol, propylene glycol, butylene glycol, diethylene glycol, dipropylene glycol, glycerol, sorbitol or the mixtures thereof) and/or
lower aliphatic alcohols, preferably, ethanol or isopropyl alcohol,
   wherein, preferably, 100 parts by weight of water relate to
(i) from about 1 to about 70, preferably, from about 5 to about 40, and more preferably from about 15 to about 30 parts by weight triacetin,
(ii) from about 1 to about 70, preferably, from about 5 to about 40, and more preferably from about 15 to about 30 parts by weight polyols, and
(iii) from about 1 to about 40, preferably from about 5 to about 30, and more preferably from about 10 to about 20 parts by weight alcohols.

The active agents, i.e. the polyphenols, flavonoids or diterpene glucosides are typically also used in a dissolved state, for example, in ethylene glycol or propylene glycol or mixtures thereof, which are referred to as “LD1” for easier distinction, and mixed with the solvents or dispersants, which are referred to as “LD2”.

In contrast to preparations containing the active agents liquidly solubilised and added to food preparations in this state, in the case of the present invention it is possible to use solutions or dispersions LD1 with a clearly higher content of active agents, for example, of around 10 to 15% by weight instead of 5% by weight, as these need to remain stable only for a short time until drying. In doing so, also the desired higher loading of the carrier materials is obtained in comparison to the state of the art.

Based on the content of active agents in the solutions or dispersions LD1, the solvents or dispersants LD2 are typically used in a weight ratio of from about 1:10 to about 1:1,000, preferably, from about 1:25 to about 1:500, and specifically, from about 1:50 to 1:100.

Principally, the solutions or dispersions may be dried in any kind of contact dryer or convection dryer, which is not very critical. However, dehydration by spray drying or by fluidised-bed drying is preferred at air temperatures in the range of from 180 to 200° C. and at outlet temperatures of the dried substance of from 50 to 80° C. Alternatively, the solutions may also be subjected to freeze drying (lyophilisation).

### INDUSTRIAL APPLICATION

By using particular polysaccharides it is possible to provide highly loaded dried products of polyphenols, flavonoids or diterpene glucosides, which are clearly soluble, particularly in beverages, and may also possess improved flavour properties in comparison with preparations according to the state of the art.

Two further subject matters of the invention therefore relate, on the one hand, to
the use of polysaccharides with a content of arabinogalactan proteins of at least 11% by weight as a carrier substance during the drying of aqueous solutions or of dispersions of polyphenols, flavonoids and/or diterpene glucosides, and
the use of the substance mixtures according to the invention for the production of food products, particularly beverages and, more particularly, lemonades and iced teas, preferably, clear and physically stable beverages, and particularly, iced teas, which contain the substance mixtures according to the invention, for example, in amounts from about 0.02 to about 0.5, preferably, from about 0.03 to about 0.3 and, specifically, from about 0.05 to about 0.1% by weight on the other.

### EXAMPLES

### Examples 1 to 4, Comparison Example V1

A 12% by weight solution of a flavonoid was placed in 1,2-propylene glycol in an Ultra-Turrax tube drive, adding aqueous ethanol and triacetin. Subsequently, gum arabic and, optionally, saponins were added and a further amount of propylene glycol, and then the mixture was homogenized for about 1 minute at 3000 RPM. Clear mixtures of a composition were obtained as reflected in Table 2. Examples 1 to 4 are according to the invention, example V1 serves comparison purposes.

TABLE 2
Composition of the solutions for drying
(indication of quantity in % by weight)

| Components | 1 | 2 | 3 | 4 | V1 |
|---|---|---|---|---|---|
| Phloretin | 30 | 30 | — | — | 30 |
| Hesperetin | — | 12 | 30 | — | — |
| 1,2-Propylene glycol | Ad 100 | | | | |
| Triacetin | 200 | 200 | 200 | 200 | 200 |
| Ethanol | 50 | 50 | 50 | 50 | 50 |
| Water | 780 | 780 | 780 | 780 | 780 |
| Gum Arabic¹ | 50 | 50 | 50 | 50 | — |
| Gum Arabic² | — | — | — | — | 50 |
| Quillaja Extract, 70% | 25 | 25 | — | 25 | 25 |
| by weight in water | | | | | |
| Maltodextrin DE 18-20 | 700 | 700 | 700 | 700 | 700 |

¹Content of arabinogalactan protein: 13% by weight, ash content: 0.2% by weight
²Content of arabinogalactan protein: 4% by weight, ash content: 4% by weight
Subsequently, formulations 1, 2 and V1 were spray-dried at 190° C., while formulations 3 and 4 were subjected to freeze-drying and milling in a powder mill. All products showed a mean particle size of 0.1 mm and a water content of below 0.5% by weight at the end.

### Examples 5 to 8, Comparison Examples V2 and V3

The solid substance mixtures produced above were used for the production of soft drinks. The flavour properties were evaluated by a panel consisting of 5 trained test persons using a scale from 1 (not perceptible) to 10 (very strongly perceptible). All products were clearly soluble in the formulations. The compositions and results are summarised in Table 3 below. The mean values of 5 measurement series are shown. Examples 5 to 8 are according to the invention, examples V2 and V3 serve comparison purposes.

| Composition | 5 | 6 | 7 | 8 | V2 | V3 |
|---|---|---|---|---|---|---|
| Sucrose | 70 | 70 | 70 | 70 | 70 | 70 |
| Citric acid | 0.2 | 0.2 | 0.2 | 0.2 | 0.2 | 0.2 |
| Peach flavour | 0.1 | 0.1 | — | — | 0.1 | — |
| Lemon flavour | — | — | 0.1 | 0.1 | — | 0.1 |
| Substance mixture 1 | 0.05 | — | — | — | — | — |
| Substance mixture 2 | — | 0.05 | — | — | — | — |
| Substance mixture 3 | — | — | 0.05 | — | — | — |
| Substance mixture 4 | — | — | — | 0.05 | — | — |
| Substance mixture V5 | — | — | — | — | 0.05 | 0.05 |

| | |
|---|---|
| Water | Ad 1000 |

Evaluation of the flavour

| | | | | | | |
|---|---|---|---|---|---|---|
| Full-bodied and | 7 | 7 | 8 | 8 | 6 | 6 |
| balanced overall | | | | | | |
| impression | | | | | | |
| Fruity flavour of peach | 8 | 9 | — | — | 6 | — |
| Fruity flavour of lemon | — | — | 8 | 9 | — | 7 |
| Bitter taste | 3 | 3 | 3 | 3 | 4 | 4 |
| Stability | stable | stable | stable | stable | stable | unstable |

The examples and comparison examples show that the object of the invention was completely achieved: the final formulations proved to have a full-bodied flavour without exhibiting a significant bitter taste, but featuring an intense fruity aroma. This becomes particularly apparent when comparing the substance mixtures according to the invention 1 to 4 with Example V1: it shows that the used polysaccharides with a high arabinogalactan protein content and a low ash content yield a considerable improvement in taste in comparison with similar substance mixtures, which were produced on the basis of conventional gum arabic. Flavour is further improved by using polysaccharide and saponin carriers.

1. Substance mixtures, comprising
(a) polyphenols, flavonoids and/or diterpene glucosides,
(b) polysaccharides and optionally
(c) saponins
with the proviso that the content of arabinogalactan proteins in component (b) is at least 11% by weight.

2. Substance mixtures according to claim 1, wherein the polyphenols, flavonoids or diterpene glucosides (component a) are selected from the group consisting of chalcones, flavones, flavonols, flavanols, flavanones, flavanonols, isoflavones, anthocyanidins and aurones.

3. Substance mixtures according to claim 1, wherein the flavonoids (component a) are dihydrochalcones or flavanones.

4. Substance mixtures according to claim 1, wherein the flavonoids (component a) are phloretin or hesperetin or mixtures thereof.

5. Substance mixtures according to claim 1, wherein the polysaccharides (component b) are condensation products of arabinose, galactose, rhamnose and/or glucuronic acid.

6. Substance mixtures according to claim 1, wherein the polysaccharides (component b) is gum arabic.

7. Substance mixtures according to claim 1, wherein the polysaccharides (component b) have a content of arabinogalactan proteins of from 12 to 30% by weight.

8. Substance mixtures according to claim 1, wherein the polysaccharides (component b) have an ash content of less than 1% by weight.

9. Substance mixtures according to claim 1, wherein they have a water content of less than 5% by weight.

10. Substance mixtures according to claim 1, wherein they comprise components (a) and (b+c) in the weight ratio of from 1:99 to 80:20.

11. A process for the production of substance mixtures according to claim 1, wherein
(a) polyphenols, flavonoids and/or diterpene glucosides are dissolved or dispersed in a solvent mixture consisting of water, triacetin, polyols and alcohols,
(b) the solution or dispersion thus obtained is reacted with an aqueous polysaccharide solution with a content of arabinogalactan proteins in the gum arabic of at least 11% by weight and, optionally, saponins.
(c) the mixture obtained is dehydrated up to a residual content of a maximum of 5% by weight water and optionally
(d) the dried product is milled or granulated to a powder.

12. A process according to claim 11, wherein dehydration is carried out by spray-drying, fluidised-bed drying or lyophilisation.

13. Use of polysaccharides with a content of arabinogalactan proteins of at least 11% by weight as carrier substances during the drying of aqueous solutions or dispersions of polyphenols, flavonoids and/or diterpen glucosides.

14. Use of substance mixtures according to claim 1 for the production of foods.

15. Foods comprising the substance mixtures according to claim 1.

16. Substance mixtures according to claim 2, wherein the flavonoids (component a) are dihydrochalcones or flavanones.

17. Substance mixtures according to claim 16, wherein the flavonoids (component a) are phloretin or hesperetin or mixtures thereof.

18. Substance mixtures according to claim 3, wherein the flavonoids (component a) are phloretin or hesperetin or mixtures thereof.

19. Substance mixtures according to claim 2, wherein the flavonoids (component a) are phloretin or hesperetin or mixtures thereof.

20. Substance mixtures according to claim 17, wherein the polysaccharides (component b) are condensation products of arabinose, galactose, rhamnose and/or glucuronic acid.
